(19) United States
(12) Patent Application Publication
(10) Pub. No.: US 2026/0254222 A1
(43) Pub. Date: Aug. 27, 2026

(54) SENSOR DEVICE

(71) Applicant: Sumitomo Wiring Systems, Ltd., Yokkaichi-shi, Mie (JP)

(72) Inventors: Yukitoshi TERASAKA, Suzuka-shi, Mie (JP); Toshinari KOBAYASHI, Suzuka-shi, Mie (JP); Megumi YAMAO, Suzuka-shi, Mie (JP); Hiroyuki KOYANO, Suzuka-Shi, Mie (JP); Hironobu YAMAMOTO, Suzuka-Shi, Mie (JP)

(73) Assignee: Sumitomo Wiring Systems, Ltd., Yokkaichi-shi, Mie (JP)

(21) Appl. No.: 18/730,392

(22) PCT Filed: Jan. 26, 2023
(86) PCT No.: PCT/JP2023/000182

§ 371 Date: Jul. 19, 2024

(30) Foreign Application Priority Data
Jan. 21, 2022 (JP) 2022-008143

(51) Int. Cl. H02G 15/076; G01D 11/24; H02G 1/14

(52) U.S. Cl. CPC H02G 15/076; G01D 11/245; H02G 1/145

(57) ABSTRACT

A sensor device includes: an internal component including a sensor element; a wire extending from the internal component; an outer resin molded part including a component covering part configured to cover at least a portion of the internal component, and a wire covering part configured to cover a portion of the wire that extends from the internal component; and a bracket including a surrounding part configured to surround the wire covering part, and a fixing part protruding outward from the surrounding part, wherein the wire includes a bent lead-out part extending from a location where the wire is bent inside the wire covering part to a location where the wire is led out from the wire covering part, and the bracket includes a receiving part having a receiving surface configured to receive at least a portion of an outer circumference of the bent lead-out part inside the wire covering part.

### CROSS-REFERENCE TO RELATED APPLICATIONS

This application is the U.S. national stage of PCT/JP2023/000182 filed on Jan. 6, 2023, which claims priority of Japanese Patent Application No. JP 2022-008143 filed on Jan. 21, 2022, the contents of which are incorporated herein.

### TECHNICAL FIELD

The present disclosure relates to a sensor device.

### BACKGROUND

JP 2021-146663A discloses a composite molded component including an internal component, a primary molded part, and a secondary molded part. In the composite molded component, a screwing part is also formed in one piece with the secondary molded part. A wire extending out from the internal component is led out to the outside through the primary molded part and the secondary molded part.

It is conceivable that the wire is kept bent inside the secondary molded part. In this case, it is desired that a bent portion be more reliably covered by the secondary molded part.

Therefore, an object of the present disclosure is to enable a bent lead-out part of a wire to be more reliably covered by an outer resin molded part.

### SUMMARY

A sensor device according to the present disclosure is a sensor device including: an internal component including a sensor element; a wire extending out from the internal component; an outer resin molded part including a component covering part configured to cover at least a portion of the internal component, and a wire covering part configured to cover a portion of the wire that extends out from the internal component; and a bracket including a surrounding part configured to surround the wire covering part, and a fixing part protruding outward from the surrounding part, wherein the wire includes a bent lead-out part extending from a location where the wire is bent inside the wire covering part to a location where the wire is led out from the wire covering part, and the bracket includes a receiving part having a receiving surface configured to receive at least a portion of an outer circumference of the bent lead-out part inside the wire covering part.

### Advantageous Effects

According to the present disclosure, a bent lead-out part of a wire can be more reliably covered by an outer resin molded part.

### BRIEF DESCRIPTION OF DRAWINGS

FIG. 1 is a perspective view showing a sensor device according to an embodiment.

FIG. 2 is a perspective view showing a bracket of the sensor device.

FIG. 3 is a cross-sectional view taken along the line III-III in FIG. 1.

FIG. 4 is a cross-sectional view taken along the line IV-IV in FIG. 1.

### DETAILED DESCRIPTION OF PREFERRED EMBODIMENTS

First, aspects of the present disclosure will be listed and described.

A sensor device according to the present disclosure is as follows.

In a first aspect, a sensor device includes: an internal component including a sensor element; a wire extending out from the internal component; an outer resin molded part including a component covering part configured to cover at least a portion of the internal component, and a wire covering part configured to cover a portion of the wire that extends out from the internal component; and a bracket including a surrounding part configured to surround the wire covering part, and a fixing part protruding outward from the surrounding part, wherein the wire includes a bent lead-out part extending from a location where the wire is bent inside the wire covering part to a location where the wire is led out from the wire covering part, and the bracket includes a receiving part having a receiving surface configured to receive at least a portion of an outer circumference of the bent lead-out part inside the wire covering part.

With such a sensor device, the wire covering part can be molded while at least a portion of the outer circumference of the bent lead-out part is received by the receiving surface. This stabilizes the position of the bent lead-out part inside the wire covering part, and the bent lead-out part is more reliably covered by the outer resin molded part.

In a second aspect, in the sensor device according to the first aspect, the receiving surface may have a shape to come into contact with a portion of the bent lead-out part in a circumferential direction of the bent lead-out part. This allows the bent lead-out part to be easily brought into contact with the receiving surface.

In a third aspect, in the sensor device according to the first or the second aspect, the outer resin molded part may have a gate mark into which molten resin is to be injected, and at least a portion of the bent lead-out part may be located between the gate mark and the receiving surface.

In this case, a resin pressure during injection of the molten resin from the gate can be effectively received by the receiving surface. This stabilizes the position of the bent lead-out part inside the outer resin molded part.

In a fourth aspect, in the sensor device according to any one of the first to the third aspects, the receiving surface may receive at least a portion of the bent lead-out part from an inner circumferential side of the bent lead-out part.

In this case, the wire is likely to be kept bent inside a mold such that at least a portion of the bent lead-out part is pressed against the receiving surface.

In a fifth aspect, in the sensor device according to any one of the first through the fourth aspects, the receiving part may have an exposed surface exposed from the outer resin molded part.

This allows the exposed surface to be abutted against a mold for molding the outer resin molded part. Also, the receiving surface can receive the wire while the receiving part is abutted against the mold.

In a sixth aspect, in the sensor device according to the fifth aspect, the receiving part may have a plurality of the exposed surfaces, and a portion of the receiving part that is located between the plurality of exposed surfaces may be covered by the outer resin molded part.

In this case, a portion between the plurality of exposed surfaces is covered by the outer resin molded part, and therefore the receiving part is unlikely to be separated from the outer resin molded part.

In a seventh aspect, in the sensor device according to any one of the first through the sixth aspects, at least a portion of a bent portion of the bent lead-out part may be located inside the surrounding part.

This stabilizes the position of the bent lead-out part inside the wire covering part even when at least a portion of a bent portion of the bent lead-out part is located inside the surrounding part.

Specific examples of the sensor device according to the present disclosure will be described below with reference to the drawings. It should be noted that the present disclosure is not limited to these examples, but is defined by the claims, and is intended to include all modifications which fall within the scope of the claims and the meaning and scope of equivalents thereof.

### Embodiment

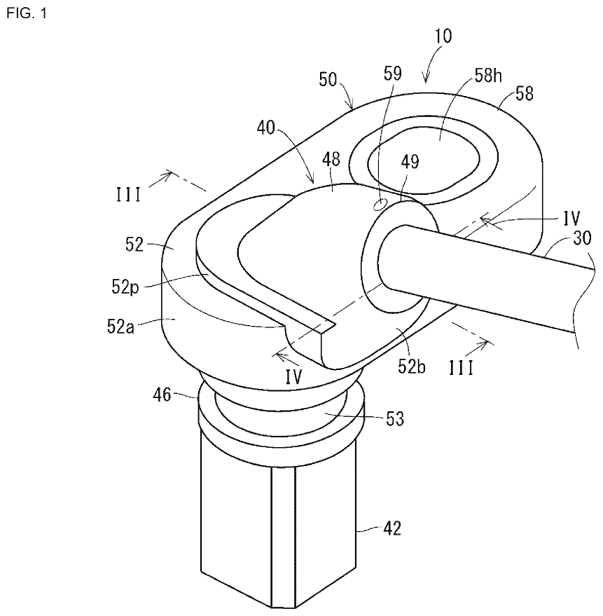

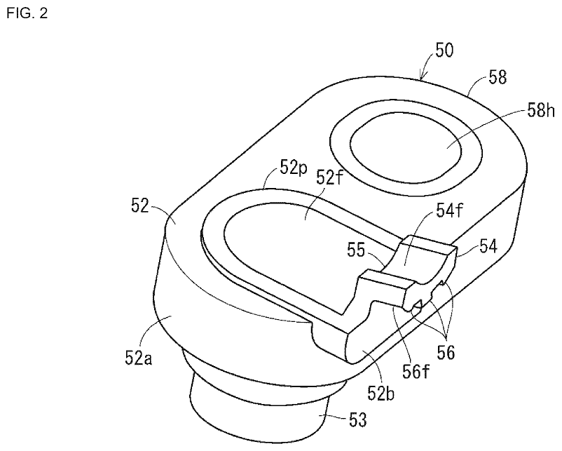

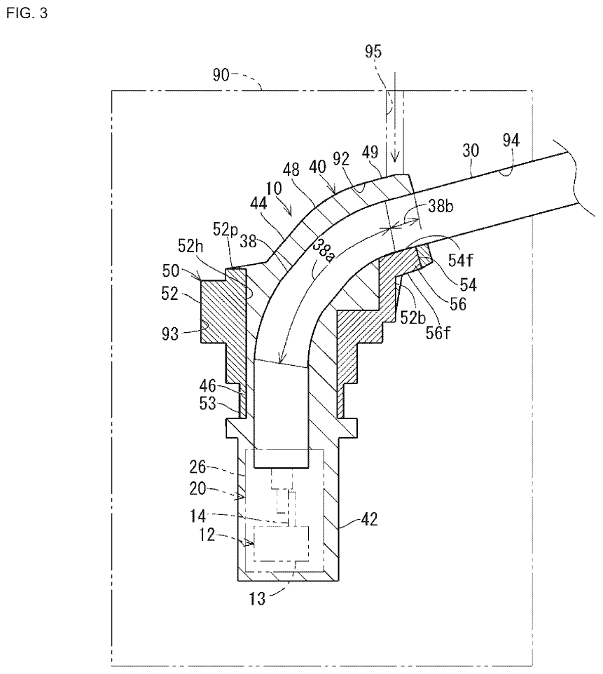

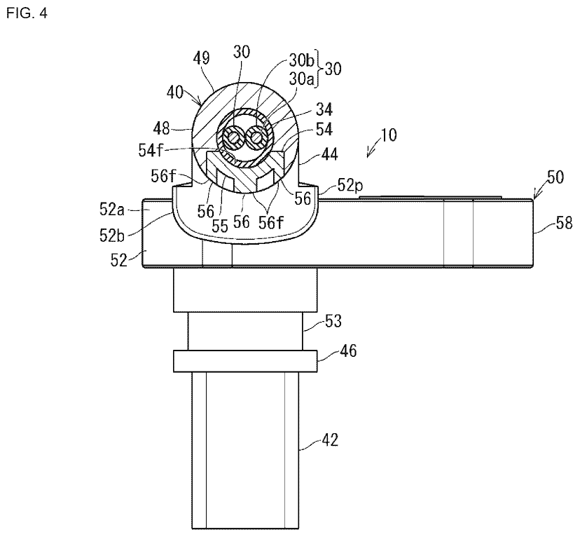

A sensor device according to an embodiment will be described below. FIG. 1 is a perspective view showing a sensor device 10. FIG. 2 is a perspective view showing a bracket 50 of the sensor device. FIG. 3 is a cross-sectional view taken along the line III-III in FIG. 1. FIG. 4 is a cross-sectional view taken along the line IV-IV in FIG. 1. In FIGS. 3 and 4, external shapes of an internal component 20 and wires 30 are shown in cross section. In FIG. 3, an external shape of a mold 90 for molding an outer resin molded part 40 is shown.

The sensor device 10 includes an internal component 20, at least one wire 30, and an outer resin molded part 40, and a bracket 50. The internal component 20 includes a sensor element 12 (see FIG. 3). Inside the internal component 20, the sensor element 12 is connected to an end portion of the wire 30. The outer resin molded part 40 covers the internal component 20, and a portion of the wire 30 that extends out from the internal component 20. The bracket 50 is integrated in one piece with the outer periphery of the outer resin molded part 40. The bracket 50 protrudes outward from the outer resin molded part 40. The sensor device 10 is to be fixed to a fixing target of the sensor device 10 via the bracket 50. The wire 30 is bent inside the outer resin molded part 40. The direction in which the wire 30 extends out from the outer resin molded part 40 is different from the direction in which the wire 30 is led out from the internal component 20. The direction in which the wire 30 is led out from the outer resin molded part 40 is set according to the path of the wire 30 in the fixing target of the sensor device 10, and the position of a connection destination of the wire 30. Examples of possible fixing targets of the sensor device 10 include a vehicle, more specifically, a component located in the vicinity of a wheel.

More specifically, the internal component 20 is a component including the sensor element 12.

The sensor element 12 is an element that detects a physical quantity such as magnetism, light, and temperature, or an amount of change thereof. Here, the sensor element 12 includes an element body 13 and at least one lead part 14. The element body 13 is formed in a square shape, for example. The lead part 14 is an elongated portion made of metal or the like. The lead part 14 extends outward from the element body 13. An output signal from the sensor element 12 is externally output via the wire 30. The sensor device 10 can be used, for example, as a sensor that detects a rotational speed of a wheel in a vehicle. More specifically, the sensor device 10 may be used as a sensor for an anti-lock brake system (ABS).

The internal component 20 includes an inner holder part 26. The inner holder part 26 is a resin portion covering a connection portion between the sensor element 12 and the wire 30. The inner holder part 26 is a resin molded portion molded using, for example, as insert portions, the sensor element 12, and a connection portion between the lead part 14 and the wire 30.

It is not essential that the inner holder part 26 is a component formed by molding using the sensor element 12 and so forth as insert portions. For example, the inner holder part 26 may be molded into a shape in which the sensor element 12 can be fitted, and the sensor element 12 may be fitted in the inner holder part 26. It is also not essential that the sensor device 10 includes the inner holder part 26. The outer resin molded part 40 may directly cover the sensor element 12.

The wire 30 is connected to the sensor element 12, and extends out from the internal component 20. The wire 30 includes a core wire 30a serving as a conductor, and an insulating coating 30b covering the periphery of the core wire 30a. The sensor device 10 includes the number of wires 30 corresponding to the number of lead parts 14 of the sensor element 12. For example, the sensor element 12 includes two lead parts 14, and the sensor device 10 includes two wires 30. The plurality of wires 30 are covered by a sheath 34 in a bundled state. The sheath 34 is a coating made of resin or the like. The plurality of wires 30 extend out from an end portion of the sheath 34. The core wires 30a are exposed at end portions of the plurality of wires 30. The core wires 30a at the respective end portions of the plurality of wires 30 are connected to the corresponding lead parts 14. The connection between the core wires 30a and the corresponding lead parts 14 may be achieved through soldering or crimping, for example. The sensor device 10 may include one wire 30. The plurality of wires 30 may not be covered by the sheath.

The inner holder part 26 covers the sensor element 12, the connection portion between each of the lead parts 14 and the corresponding wire 30, and end portions of the wires 30 that are located on the sensor element 12 side, and the wires 30 extend out from the internal component 20.

The longitudinal direction of the internal component 20 coincides with the longitudinal direction of the lead parts 14 of the sensor element 12. In the present embodiment, the direction in which the wires 30 extend out from the internal component 20 coincides with the longitudinal direction of the internal component 20; however, this is not essential.

The outer resin molded part 40 is a resin portion molded using, as insert portions, the internal component 20, portions of the wires 30 that are led out from the internal component 20. As a result of the outer resin molded part 40 covering the sensor element 12 with the inner holder part 26 interposed between the outer resin molded part 40 and the sensor element 12, the water stop property for the sensor element 12 is increased.

The outer resin molded part 40 includes a component covering part 42 and a wire covering part 44. The component covering part 42 covers at least a portion of the internal component 20. The wire covering part 44 covers portions of the wires 30 that extend out from the internal component 20.

More specifically, the component covering part 42 is formed in an elongated shape, in this case, a rectangular parallelepiped shape, covering the internal component 20. Preferably, the component covering part 42 covers the entire outer periphery of the internal component 20. A portion of the internal component 20 may be exposed to the outside without being covered by the component covering part 42.

The wire covering part 44 is connected to an end portion of the component covering part 42 that is located on a side where the wires 30 extend out, and covers end portions of the wires 30. In the present embodiment, the wire covering part 44 includes a covering body 46 and a lead-out covering part 48. The covering body 46 extends linearly from the component covering part 42. The lead-out covering part 48 is connected to the covering body 46 on a side opposite to the component covering part 42. The lead-out covering part 48 extends so as to be bent in an arc shape with respect to the component covering part 42. An end portion of the lead-out covering part 48 is oriented in a direction in which the end portion forms an obtuse angle to the covering body 46.

Each of the wires 30 extends linearly from the internal component 20 to a midpoint of the covering body 46, and is bent in an arc shape at the midpoint of the covering body 46. For example, a bent portion 38a of the wire 30 is bent so as to form an angle of 90° or less, for example, 80° or less. A portion of the bent portion 38a of the wire 30 is embedded in the covering body 46, and the remaining portion is embedded in the lead-out covering part 48. A portion of the wire 30 that is located on a side opposite to the internal component 20 with respect to the bent portion 38a constitutes a straight portion 38b extending linearly and embedded in an end portion of the lead-out covering part 48. A portion of the wire 30 that extends from a location where the wire 30 starts to be bent inside the wire covering part 44 to a location where the wire 30 is led out from the wire covering part 44 constitutes a bent lead-out part 38. In the present embodiment, the bent lead-out part 38 includes the bent portion 38a and the straight portion 38b.

The bracket 50 includes a surrounding part 52 and a fixing part 58. The bracket 50 may be, for example, a resin portion molded using the outer resin molded part 40 as an insert portion.

The surrounding part 52 surrounds the wire covering part 44 of the outer resin molded part 40. In the present embodiment, the surrounding part 52 includes a through hole 52h in which a portion of the wire covering part 44 in the longitudinal direction thereof can be disposed. More specifically, the surrounding part 52 includes a portion 52a having a U-shaped external shape, and a protrusion 52b protruding outward from one side of the U-shaped portion. The through hole 52h is formed as an elongated hole extending from the center of the portion 52a to the protrusion 52b of the surrounding part 52. The through hole 52h has the shape of a semicircular hole on the portion 52a side of the surrounding part 52, and has the shape of a square hole on the protrusion 52b side. A portion of the wire covering part 44 in the longitudinal direction is disposed inside the through hole 52h. That is, the surrounding part 52 surrounds a portion of the outer circumference of the wire covering part 44 in the longitudinal direction. At an opening edge of the through hole 52h of the surrounding part 52, a surrounding protrusion 52p protruding beyond the peripheral area of the opening edge is formed.

A portion of the lead-out covering part 48 that is located on a side opposite to the sensor element 12 protrudes from a surface of the bracket 50 that is located on a side opposite to the sensor element 12. An end portion of the lead-out covering part 48 that is located on a side opposite to the sensor element 12 is formed as an end portion covering part 49 protruding further outward from the protrusion 52b.

An extension tube part 53 extends toward the internal component 20 from the peripheral area of the through hole 52h of the surrounding part 52. The extension tube part 53 is connected in one piece with the surrounding part 52 to surround the wire covering part 44 together.

The surrounding part 52 is located so as to surround at least a portion of the bent portion 38a of the bent lead-out part 38, with the wire covering part 44 interposed between the surrounding part 52 and the aforementioned portion of the bent portion 38a. That is, the region in which the surrounding part 52 is present and the region in which the bent portion 38a is present overlap each other in the longitudinal direction of the covering body 46.

The outer resin molded part 40 is molded using the bracket 50 as an insert portion. Accordingly, the inner circumferential surface of the through hole 52h of the bracket 50 is joined in one piece with the outer circumferential surface of the bracket 50, thus integrating the bracket 50 in one piece with the outer resin molded part 40.

The fixing part 58 is connected to a portion of the outer circumference of the surrounding part 52, and extends outward from the portion of the outer circumference of the surrounding part 52. In the present embodiment, the surrounding part 52 and the fixing part 58 are connected to each other to form an oblong plate shape. The fixing part 58 has a screw fixing through hole 58h formed therein. As a result of a screw being passed through the through hole 58h and screwed with a screw hole of the fixing target, the sensor device 10 is screw-fixed to the fixing target. The structure for fixing the fixing part 58 to the fixing target is not limited to the above-described example. For example, the fixing part 58 may be fittingly fixed to the fixing target.

The bracket 50 includes a receiving part 54 having a receiving surface 54f. The receiving surface 54f is a surface configured to receive at least a portion of the outer circumference of the bent lead-out part 38 inside the wire covering part 44.

More specifically, let us assume that the wires pass straight through the interior of the outer resin molded part. In this case, the wires can be positioned so as to be pulled straight from the internal component at the time of molding the outer resin molded part. Accordingly, the positions of the wires are less likely to vary inside the outer resin molded part, thus allowing the wires to be more reliably covered by the outer resin molded part. In contrast, when the wires 30 are bent inside the outer resin molded part 40 as described in the present embodiment, at the time of molding the outer resin molded part 40, it may be difficult to dispose each of the bent lead-out parts 38 at a fixed position inside the outer resin molded part 40. In addition, the bent lead-out parts 38 may possibly be moved by a resin pressure inside the mold. In that case, the positions of the bent lead-out parts 38 inside the outer resin molded part 40 may vary, and the bent lead-out parts 38 may possibly be exposed at a midway of the outer resin molded part 40. In this case, the wires 30 will be exposed in the vicinity of the internal component 20.

Therefore, the receiving surface 54f receives at least a portion of the outer circumference of each of the bent lead-out parts 38 at the time of molding the outer resin molded part 40. The receiving surface 54f allows the bent lead-out parts 38 to be positioned at the respective fixed positions inside the outer resin molded part 40. Accordingly, end portions of the wires 30 that are located in the vicinity of the sensor element 12 can be more reliably covered by the outer resin molded part 40.

More specifically, the receiving part 54 includes a partial tube part 55 and at least one partial protrusion 56.

The partial tube part 55 protrudes outward from a portion of the opening edge of the through hole 52h in the circumferential direction. In the present embodiment, a proximal end portion of the partial tube part 55 is connected to a square portion (protrusion 52b) of the opening edge of the through hole 52h. The partial tube part 55 protrudes from the protrusion 52b toward a direction away from the center of the through hole 52h. In the present embodiment, the direction in which the fixing part 58 protrudes and the direction in which the receiving part 54 protrudes are orthogonal to each other, as viewed along a central axis of the through hole 52h.

In addition, the partial tube part 55 extends obliquely to the central axis of the through hole 52h. Here, the partial tube part 55 is inclined toward a side away from the sensor element 12 with respect to a direction orthogonal to the central axis of the through hole 52h. Note that the direction in which the central axis of the through hole 52h extends coincides with the longitudinal direction of the internal component 20, and also coincides with the longitudinal direction of straight portions of the wires 30 that extend from the internal component 20 to the bent lead-out parts 38.

An inner circumferential surface, or in other words, a surface of the partial tube part 55 that is located on a side opposite to the sensor element 12 is formed as the receiving surface 54f having an arc-shaped transverse cross section. Note that a transverse cross section is a cross section on a plane orthogonal to the longitudinal direction of the partial tube part 55. The radius of curvature of the receiving surface 54f is set to, for example, a size conforming to the external shape of the wires 30 extending out from the sensor element 12. For example, the radius of curvature of the receiving surface 54f is set to be the same as the radius of the sheath 34. As in the case of the longitudinal direction of the partial tube part 55, the longitudinal direction of the receiving surface 54f is also inclined toward a side away from the sensor element 12 with respect to the central axis of the through hole 52h.

Thus, the receiving surface 54f of the partial tube part 55 has a shape to come into contact with a portion of each of the bent lead-out parts 38 in the circumferential direction. Here, the receiving surface 54f is formed to have an arc-shaped transverse cross section, and thus can come into surface contact with a portion of the outer circumferential surface of each of the bent lead-out parts 38. Preferably, the receiving surface 54f has an arc-shaped transverse cross section smaller than a semicircle. This allows the wires 30 to be easily brought into contact with the receiving surface 54f. The receiving surface 54f may have a U-shape having an arc-shaped transverse cross section.

It is not essential that the receiving surface 54f is formed in the above-described shape. The receiving surface may be formed as a plane. A plurality of protrusions may be formed at intervals along the circumferential direction of the bent lead-out parts 38, and the receiving surface may be formed on a distal end of each of the plurality of protrusions.

Each of the bent lead-out parts 38 is led out so as to be bent toward the receiving part 54 side in the through hole 52h and a location where the bent lead-out part 38 exits the through hole 52h. This enables the receiving surface 54f to receive at least a portion of the bent lead-out part 38 from the inner circumferential side of the bent lead-out part 38. For example, while the wires 30 are passed through the through hole 52h of the bracket 50, portions of the wires 30 that are located on a side opposite to the sensor element 12 are pressed toward the sensor element 12 side, or pulled while being bent. Then, a portion of each of the bent lead-out parts 38 that is led out from the through hole 52h is pressed toward the receiving surface 54f. Thus, the inner circumferential-side portion of the bent lead-out part 38 is pressed against the receiving surface 54f, whereby the bent lead-out part 38 is positioned at a stable position.

The point of contact between the receiving surface 54f and each of the bent lead-out parts 38 is located inside the end portion covering part 49. In the present embodiment, of the contact surface between the receiving surface 54f and each of the bent lead-out parts 38, both edges in the circumferential direction and a proximal end-side edge of the bent lead-out part 38 are located inside the end portion covering part 49. That is, the receiving surface 54f of the receiving part 54 is in contact with a portion of the outer circumference of the bent lead-out part 38 inside the end portion covering part 49. Thus, a portion of the bent lead-out part 38 that is positioned by the receiving part 54 is embedded, together with the receiving part 54, inside the end portion covering part 49 of the lead-out covering part 48. In the vicinity of the receiving part 54, a portion of the outer circumference of the bent lead-out part 38 is covered by the receiving part 54, and the remaining portion of the outer circumference of the bent lead-out part 38 is covered by the end portion covering part 49.

The partial protrusion 56 partially protrudes from the outer circumferential surface of the partial tube part 55. A portion of the outer circumferential surface of the partial tube part 55 excluding the partial protrusion 56 is covered by the end portion covering part 49. A distal end surface of the partial tube part 55 is constituted by an exposed surface 56f exposed from the end portion covering part 49 of the outer resin molded part 40.

In the present embodiment, a plurality of (three in this case) partial protrusions 56 are formed on the outer circumferential surface of the partial tube part 55 along the circumferential direction thereof. Gaps are formed between the plurality of partial protrusions 56. Portions of the partial tube part 55 that are located between the plurality of partial protrusions 56 are covered by the end portion covering part 49 of the outer resin molded part 40. A distal end surface of each of the plurality of partial protrusions 56 is exposed so as to be successively connected to the outer circumferential surface of the end portion covering part 49.

An example of the operation of molding the above-described outer resin molded part 40 will now be described. As shown in FIG. 3, a mold 90 having a mold surface 92 corresponding to the shape of the outer surface of the outer resin molded part 40 is prepared. A positioning surface 93 for positioning the bracket 50, and a wire positioning surface 94 for positioning the wire 30 while leading out the wire 30 are formed on the mold 90. It is also envisaged that a positioning pin for positioning the internal component 20 may be formed on the mold 90. A gate 95 for injecting molten resin into the mold 90 is formed on the mold 90. For example, the gate 95 is formed so as to be open at a position of the mold surface 92 that is opposed to the receiving part 54 with respect to the bent lead-out parts 38.

With the internal component 20, the wire 30, and the bracket 50 being positioned inside the mold surface 92, molten resin is injected into the mold 90 through the gate 95. The molten resin flows into the space inside the mold surface 92 while coming into contact with the bent lead-out part 38 of the wire 30 from a side opposite to the receiving part 54. Thus, the bent lead-out part 38 is pressed toward the receiving part 54, and the pressing force is received by the receiving surface 54f. Accordingly, the bent lead-out part 38 is retained at a position at which the bent lead-out part 38 is pressed against the receiving surface 54f. That is, a state in which the bent lead-out part 38 is moved inside the mold surface 92 to come into contact with the mold surface 92 is unlikely to occur, and a state in which a gap is present between the bent lead-out part 38 and the mold surface 92 is likely to be maintained more reliably. Accordingly, the bent lead-out part 38 is more reliably covered by the outer resin molded part 40.

After the molten resin has been cured inside the mold surface 92, the sensor device 10 is demolded from the mold 90. A gate mark 59 is assumed to be formed at a portion of the outer resin molded part 40 of the demolded sensor device 10 that corresponds to the gate 95. The gate mark 59 is a dividing mark with the resin cured inside the gate 95, and is assumed to have irregularities in the form of cutting marks or machining marks. For example, the gate mark 59 may possibly be formed at a position of the outer surface of the outer resin molded part 40 that is opposed to the receiving surface 54f. In this case, at least a portion of the bent lead-out part 38 is located between the gate mark 59 and the receiving surface 54f.

With the sensor device 10 configured in the above-described manner, the wire 30 includes a bent lead-out part 38, and the bracket 50 includes a receiving part 54 having a receiving surface 54f configured to receive at least a portion of the outer circumference of the bent lead-out part 38 inside the wire covering part 44. Accordingly, the wire covering part 44 can be molded while at least a portion of the outer circumference of the bent lead-out part 38 is received by the receiving surface 54f. This stabilizes the position of the bent lead-out part 38 inside the wire covering part 44, and the bent lead-out part 38 is more reliably covered by the outer resin molded part 40. This allows the wire 30 to be covered by the outer resin molded part 40 over a length suitable for stopping water, thus securing the desired water stop property. Since the wire can be reliably covered by the resin, the outer resin molded part need not be molded by a plurality of separate molding processes. Accordingly, the productivity is enhanced, and a cost reduction can also be achieved.

The receiving surface 54f is in contact with a portion of the bent lead-out part 38 in the circumferential direction. In the case where the bent lead-out part is positioned by an annular receiving surface, the wire will be passed through the annular receiving surface. As compared with such a case, the receiving surface 54f can be easily brought into contact with the bent lead-out part 38.

The bent lead-out part 38, the gate mark 59, and the receiving surface 54f are in a relationship in which at least a portion of the bent lead-out part 38 is located between the gate mark 59 and the receiving surface 54f. Accordingly, when a resin pressure during injection of the molten resin presses the bent lead-out part 38 at the time of molding the outer resin molded part 40, the pressing force is effectively received by the receiving surface 54f. This stabilizes the position of the bent lead-out part 38 inside the outer resin molded part 40. Thus, the bent lead-out part 38 is more reliably covered by the outer resin molded part 40.

The receiving surface 54f receives at least a portion of the bent lead-out part 38 from the inner circumferential side of the bent lead-out part 38. Accordingly, the wire 30 is likely to be kept bent inside the mold 90 such that at least a portion of the bent lead-out part 38 is pressed against the receiving surface 54f. The wire 30 can be kept pressed against the receiving surface 54f, for example, by pulling the wire 30, or pushing the wire 30 toward the inner circumferential side, at a position outward of the mold surface 92.

The bent lead-out part 38 can be pressed against the receiving surface 54f by injecting molten resin via the gate 95 formed on the outer circumferential side relative to the bent lead-out part 38 on the mold 90.

The receiving part 54 has the exposed surface 56f exposed from the outer resin molded part 40. This allows the exposed surface 56f to be pressed against the mold surface 92 at the time of molding the outer resin molded part 40. Accordingly, the receiving surface 54f can receive the bent lead-out part 38 while the receiving part 54 is abutted against the mold surface 92, so that the position of the bent lead-out part 38 is further stabilized.

The receiving part 54 includes a plurality of exposed surfaces 56f, and portions of the receiving part 54 that are located between the plurality of exposed surfaces 56f are covered by the outer resin molded part 40. Accordingly, the receiving part 54 is unlikely to be separated from the outer resin molded part 40.

At least a portion of the bent portion 38a of the bent lead-out part 38 is located inside the surrounding part 52. Accordingly, the length of the bent portion 38a can be easily increased to increase the minimum bending radius. In this case as well, the position of the bent lead-out part 38 inside the wire covering part 44 is stabilized.

Note that, in the above-described embodiment, the receiving part 54 may be provided at any position. The receiving part may come into contact with the bent lead-out part 38 on the outer circumferential side of the bent lead-out part 38, or may come into contact with the bent lead-out part 38 from a direction orthogonal to a plane through which the bent lead-out part 38 passes.

A portion of the receiving part 54 need not be exposed from the outer resin molded part 40, or the whole of the receiving part may be embedded inside the outer resin molded part.

The configurations described in the embodiment and the modification may be combined as appropriate as long as there are no mutual inconsistencies.

1. A sensor device comprising:
an internal component including a sensor element;
a wire extending out from the internal component;
an outer resin molded part including a component covering part configured to cover at least a portion of the internal component, and a wire covering part configured to cover a portion of the wire that extends out from the internal component; and
a bracket including a surrounding part configured to surround the wire covering part, and a fixing part protruding outward from the surrounding part,
wherein the wire includes a bent lead-out part extending from a location where the wire is bent inside the wire covering part to a location where the wire is led out from the wire covering part, and
the bracket includes a receiving part having a receiving surface configured to receive at least a portion of an outer circumference of the bent lead-out part inside the wire covering part.

2. The sensor device according to claim 1, wherein the receiving surface has a shape to come into contact with a portion of the bent lead-out part in a circumferential direction of the bent lead-out part.

3. The sensor device according to claim 1,
wherein the outer resin molded part has a gate mark into which molten resin is to be injected, and
at least a portion of the bent lead-out part is located between the gate mark and the receiving surface.

4. The sensor device according to claim 1, wherein the receiving surface receives at least a portion of the bent lead-out part from an inner circumferential side of the bent lead-out part.

5. The sensor device according to claim 1, wherein the receiving part has an exposed surface exposed from the outer resin molded part.

6. The sensor device according to claim 5,
wherein the receiving part has a plurality of the exposed surfaces, and
a portion of the receiving part that is located between the plurality of exposed surfaces is covered by the outer resin molded part.

7. The sensor device according to claim 1, wherein at least a portion of a bent portion of the bent lead-out part is located inside the surrounding part.

8. The sensor device according to claim 2,
wherein the outer resin molded part has a gate mark into which molten resin is to be injected, and
at least a portion of the bent lead-out part is located between the gate mark and the receiving surface.

9. The sensor device according to claim 2, wherein the receiving surface receives at least a portion of the bent lead-out part from an inner circumferential side of the bent lead-out part.

10. The sensor device according to claim 3, wherein the receiving surface receives at least a portion of the bent lead-out part from an inner circumferential side of the bent lead-out part.

11. The sensor device according to claim 2, wherein the receiving part has an exposed surface exposed from the outer resin molded part.

12. The sensor device according to claim 3, wherein the receiving part has an exposed surface exposed from the outer resin molded part.

13. The sensor device according to claim 4, wherein the receiving part has an exposed surface exposed from the outer resin molded part.

14. The sensor device according to claim 2, wherein at least a portion of a bent portion of the bent lead-out part is located inside the surrounding part.

15. The sensor device according to claim 3, wherein at least a portion of a bent portion of the bent lead-out part is located inside the surrounding part.

16. The sensor device according to claim 4, wherein at least a portion of a bent portion of the bent lead-out part is located inside the surrounding part.

17. The sensor device according to claim 5, wherein at least a portion of a bent portion of the bent lead-out part is located inside the surrounding part.

18. The sensor device according to claim 6, wherein at least a portion of a bent portion of the bent lead-out part is located inside the surrounding part.
